(19) United States
(12) Patent Application Publication
(10) Pub. No.: US 2023/0118452 A1
(43) Pub. Date: Apr. 20, 2023

(54) INPUT/OUTPUT MODULE, STANDARD INPUT/OUTPUT MODULE UNIT, AND SAFETY CIRCUIT UNIT

(71) Applicant: Mitsubishi Electric Corporation, Tokyo (JP)

(72) Inventor: Shogo TAKAGI, Tokyo (JP)

(73) Assignee: Mitsubishi Electric Corporation, Tokyo (JP)

(21) Appl. No.: 17/912,051

(22) PCT Filed: Jul. 6, 2020
(86) PCT No.: PCT/JP2020/026353

§ 371 Date: Sep. 16, 2022

(51) Int. Cl. G05B 19/05

(52) U.S. Cl. CPC G05B 19/054; G05B 19/058

(57) ABSTRACT

An input/output module (100) includes a standard input/output module unit (4) and a safety circuit unit (5). The standard input/output module unit (4) includes an external interface to connect with a control target device, a standard input/output module controller to receive an input signal from the control target device and transmit the input signal to a control module, or transmit a control signal received from the control module to the control target device, and a first connector including a plurality of connection points. The safety circuit unit (5) includes a diagnoser to diagnose operation states of the control target device and the standard input/output module unit, a second connector including a plurality of connection points and removably insertable into the first connector, and a safety circuit controller to control operations of the standard input/output module unit and the diagnoser with the second connector inserted in the first connector.

### TECHNICAL FIELD

The present disclosure relates to an input/output module, a standard input/output module unit, and a safety circuit unit.

### BACKGROUND ART

Input/output modules in a control device for sequence control include a standard input/output module that performs input and output control on an external control target device, and a safety input/output module that performs input and output control while diagnosing the wiring conditions of the control target device and the internal circuits of the standard input/output module. Recent trends toward safety requests and consideration for systems used in factories have increased the requests for functional safety. This has also increased the requests for safety input/output modules.

The standard input/output module includes an operation circuit for performing input and output control on the control target device connected to the module in accordance with an instruction from a central processing unit (CPU) module in the control device. The safety input/output module includes an operation circuit for performing input and output control on the control target device connected to the standard input/output module and also a diagnosis circuit for each circuit block such as a power supply circuit or an input/output control circuit included in the safety input/output module. Thus, the standard input/output module and the safety input/output module have different circuit configurations and operate as separate input/output modules.

In building a control device for sequence control, a standard input/output module or a safety input/output module is installed appropriately in accordance with the control target device. However, for example, when the standard input/output module included in the control device is changed to the safety input/output module, the whole input/output module is replaced, increasing manhours of a user. Patent Literature 1 describes, as a technique for saving the manhours of a user, for example, an input/output module that can be switched between a standard input/output module operation and a safety input/output module operation by rewriting setting information through communication from a personal computer.

### CITATION LIST

### Patent Literature

Patent Literature 1: Unexamined Japanese Patent Application Publication No. 2006-325390

### SUMMARY OF INVENTION

### Technical Problem

The input/output module with the technique described in Patent Literature 1 is a safety input/output module. The safety input/output module includes diagnosis circuits for different circuit blocks and thus includes larger circuitry than a standard input/output module. The safety input/output module includes larger circuitry than a standard input/output module and accordingly consumes more power than the standard input/output module. However, when the safety input/output module is operated as a standard input/output module, the diagnosis circuit for each circuit block continues consuming power although not operating. Thus, when operated as the standard input/output module, the safety input/output module wastes power.

When operated as the standard input/output module, the safety input/output module operates without the diagnosis circuit for each circuit block. Thus, upon a failure in any one of the diagnosis circuits for the circuit blocks, the safety input/output module can still be used as the standard input/output module although the module cannot be used as a safety input/output module. However, upon a failure in the standard input/output module, the safety input/output module cannot be used although no failure occurs in the diagnosis circuit for each circuit block. In this case, the whole safety input/output module is to be replaced, involving a waste of components.

An objective of the present disclosure is to provide an input/output module, a standard input/output module unit, and a safety circuit unit that reduce the waste of power and components.

### Solution to Problem

To achieve the above objective, an input/output module according to an aspect of the present disclosure includes a standard input/output module unit and a safety circuit unit. The standard input/output module unit includes an external interface to connect with a control target device, a standard input/output module controller to receive an input signal from the control target device and transmit the input signal to a control module, or transmit a control signal received from the control module to the control target device, and a first connector including a plurality of connection points. The safety circuit unit includes a diagnoser to diagnose operation states of the control target device and the standard input/output module unit, a second connector including a plurality of connection points and removably insertable into the first connector, and a safety circuit controller to control operations of the standard input/output module unit and the diagnoser with the second connector inserted in the first connector.

### Advantageous Effects of Invention

The input/output module according to the above aspect of the present disclosure allows the second connector of the safety circuit unit to be inserted into and extracted from the first connector of the standard input/output module unit, and reduces the waste of power and components.

### BRIEF DESCRIPTION OF DRAWINGS

FIG. 1 is a diagram of a PLC including an input/output module according to an embodiment of the present disclosure illustrating the example overall configuration;

FIG. 2 is a schematic diagram of an input standard module unit and an input safety circuit unit in the input/output module according to the embodiment of the present disclosure;

FIG. 3 is a diagram of the input standard module unit in the input/output module according to the embodiment of the present disclosure illustrating the example configuration;

FIG. 4 is a diagram of the input safety circuit unit in the input/output module according to the embodiment of the present disclosure illustrating the example configuration;

FIG. 5 is a schematic diagram of an output standard module unit and an output safety circuit unit in the input/output module according to the embodiment of the present disclosure;

FIG. 6 is a diagram of the output standard module unit in the input/output module according to the embodiment of the present disclosure illustrating the example configuration;

FIG. 7 is a diagram of the output safety circuit unit in the input/output module according to the embodiment of the present disclosure illustrating the example configuration;

FIG. 8 is a diagram of an input/output module according to a modification of the embodiment of the present disclosure; and

FIG. 9 is a diagram of an input/output module according to a modification of the embodiment of the present disclosure.

### DESCRIPTION OF EMBODIMENTS

An input/output module 100 according to an embodiment of the present disclosure is described with reference to the drawings. The same reference numerals denote the same or equivalent components.

The input/output module 100 includes a safety circuit unit 5 removably insertable into a standard input/output module unit 4, and the removable insertion allows switching as appropriate between the operation of a standard input/output module and the operation of a safety input/output module including a diagnosis circuit for each circuit block.

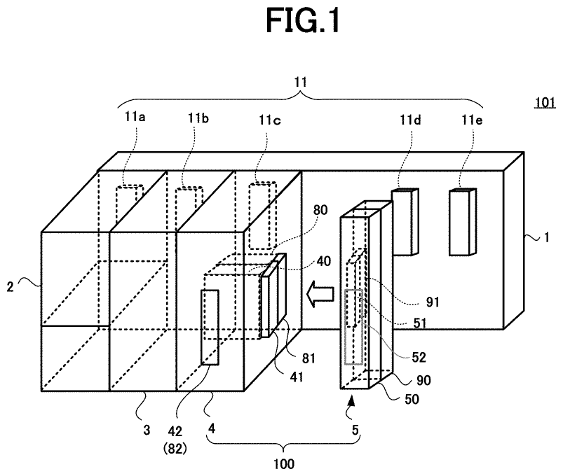

FIG. 1 is a diagram of a programmable logic controller (PLC) 101 including the input/output module 100, illustrating the example overall configuration. The PLC 101 includes a base 1 to which various modules are connected, a power supply device 2 that supplies the various modules with power, a central processing unit (CPU) module 3 that transmits and receives various signals to and from the various modules, and the input/output module 100 that performs input and output control on a control target device. The PLC 101 is a control device for sequence control and an example of a control device in the claims.

The base 1 includes couplers 11a, 11b, 11c, 11d, and 11e that allow connection with the various modules. The couplers 11a, 11b, 11c, 11d, and 11e are hereafter collectively referred to as couplers 11. The couplers 11 allow removable connection with the various modules. The various modules are connected to the base 1 with the couplers 11. The various modules transmit and receive various data items through the base 1.

The power supply device 2 is connected to the base 1 with the coupler 11a. The power supply device 2 supplies power to the various modules through the base 1. The CPU module 3 is connected to the base 1 with the coupler 11b. The CPU module 3 transmits control signals to the various modules based on data received from an external information device. The CPU module 3 receives input signals transmitted from the various modules. The CPU module 3 performs an operation on the received input signals and transmits the resultant signals to the external information device. The CPU module 3 is an example of a control module in the claims.

The input/output module 100 includes the standard input/output module unit 4 for performing input and output control on a control target device and the safety circuit unit 5 serving as a diagnosis circuit for the standard input/output module unit 4. The standard input/output module unit 4 is connected to the base 1 with the coupler 11c. The standard input/output module unit 4 includes an input standard module unit 40 and an output standard module unit 80.

The input standard module unit 40 is a unit that receives an input signal from a control target device such as a sensor or a switch. The output standard module unit 80 is a unit that transmits an output signal to a control target device such as a relay or a switch to activate the control target device.

The input standard module unit 40 includes a first connector 41. The output standard module unit 80 includes a third connector 81. The standard input/output module unit 4 includes a first interface 42, a second interface 52, and a third interface 82 that connects with control target devices.

The safety circuit unit 5 includes an input safety circuit unit 50 including a diagnosis circuit for each circuit block, and an output safety circuit unit 90. The input safety circuit unit 50 is a diagnosis circuit for diagnosing the operation state of each circuit block in the input standard module unit 40. The output safety circuit unit 90 is a diagnosis circuit for diagnosing the operation state of each circuit block in the output standard module unit 80. The input safety circuit unit 50 includes a second connector 51 removably insertable into the first connector 41 of the input standard module unit 40. The output safety circuit unit 90 includes a fourth connector 91 removably insertable into the third connector 81 of the output standard module unit 80.

The input standard module unit 40 operates singly as a standard reception module that receives an input signal from a control target device. The input standard module unit 40, with the input safety circuit unit 50 inserted in the first connector 41 with the second connector 51, can operate as a safety reception module for receiving an input signal from a control target device and diagnosing the operation state of each circuit block.

The output standard module unit 80 operates singly as a standard output module that transmits a control signal for controlling a control target device. The output standard module unit 80, with the output safety circuit unit 90 inserted in the third connector 81 with the fourth connector 91, can operate as a safety output module for transmitting a control signal for controlling a control target device and diagnosing the operation state of each circuit block.

The input standard module unit 40, the input safety circuit unit 50, the output standard module unit 80, and the output safety circuit unit 90 may be, for example, individual circuits formed on separate printed circuit boards.

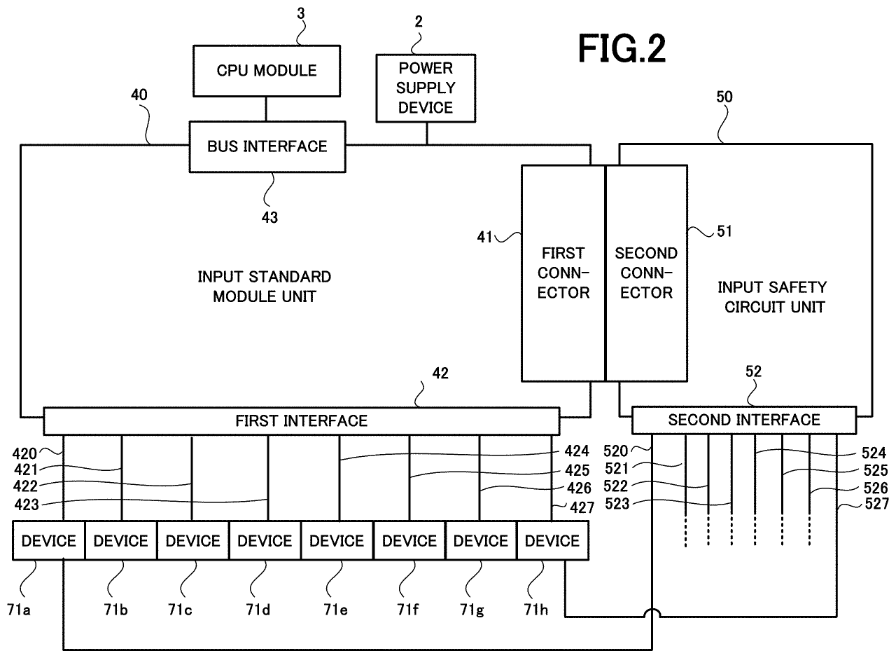

A specific configuration of the input standard module unit 40 and the input safety circuit unit 50 is described. The configuration of the input standard module unit 40 and the input safety circuit unit 50 is schematically illustrated in FIG. 2. The input standard module unit 40 includes the first connector 41 to which the input safety circuit unit 50 is connected with the second connector 51, and a bus interface 43 for transmitting and receiving various data items to and from the CPU module 3. The input standard module unit 40 receives a voltage from the power supply device 2.

The first interface 42 of the input standard module unit 40 is connected with a first input signal line 420, a second input signal line 421, a third input signal line 422, a fourth input signal line 423, a fifth input signal line 424, a sixth input signal line 425, a seventh input signal line 426, and an eighth input signal line 427. The first input signal line 420 is used to input an input signal from a device 71a to be controlled into the input standard module unit 40 through the first interface 42. The second input signal line 421 is used to input an input signal from a device 71b to be controlled into the input standard module unit 40 through the first interface 42.

The third input signal line 422 is used to input an input signal from a device 71c to be controlled into the input standard module unit 40 through the first interface 42. The fourth input signal line 423 is used to input an input signal from a device 71d to be controlled into the input standard module unit 40 through the first interface 42. The fifth input signal line 424 is used to input an input signal from a device 71e to be controlled into the input standard module unit 40 through the first interface 42.

The sixth input signal line 425 is used to input an input signal from a device 71f to be controlled into the input standard module unit 40 through the first interface 42. The seventh input signal line 426 is used to input an input signal from a device 71g to be controlled into the input standard module unit 40 through the first interface 42. The eighth input signal line 427 is used to input an input signal from a device 71h to be controlled into the input standard module unit 40 through the first interface 42. The devices 71a to 71h are hereafter collectively referred to as devices 71.

The input safety circuit unit 50 includes the second connector 51 for connection with the input standard module unit 40, and the second interface 52 for connection to the devices 71. The input safety circuit unit 50 can diagnose the operation state of the input standard module unit 40 and also the operation states of the devices 71.

The second interface 52 is connected with a first diagnosis line 520, a second diagnosis line 521, a third diagnosis line 522, a fourth diagnosis line 523, a fifth diagnosis line 524, a sixth diagnosis line 525, a seventh diagnosis line 526, and an eighth diagnosis line 527. The first diagnosis line 520 is connected to the device 71a. The second diagnosis line 521 is connected to the device 71b. The third diagnosis line 522 is connected to the device 71c. The fourth diagnosis line 523 is connected to the device 71d. The fifth diagnosis line 524 is connected to the device 71e. The sixth diagnosis line 525 is connected to the device 71f. The seventh diagnosis line 526 is connected to the device 71g. The eighth diagnosis line 527 is connected to the device 71h. These connections allow the input safety circuit unit 50 to diagnose the operation states of the devices 71a to 71h through the first diagnosis line 520 to the eighth diagnosis line 527, respectively.

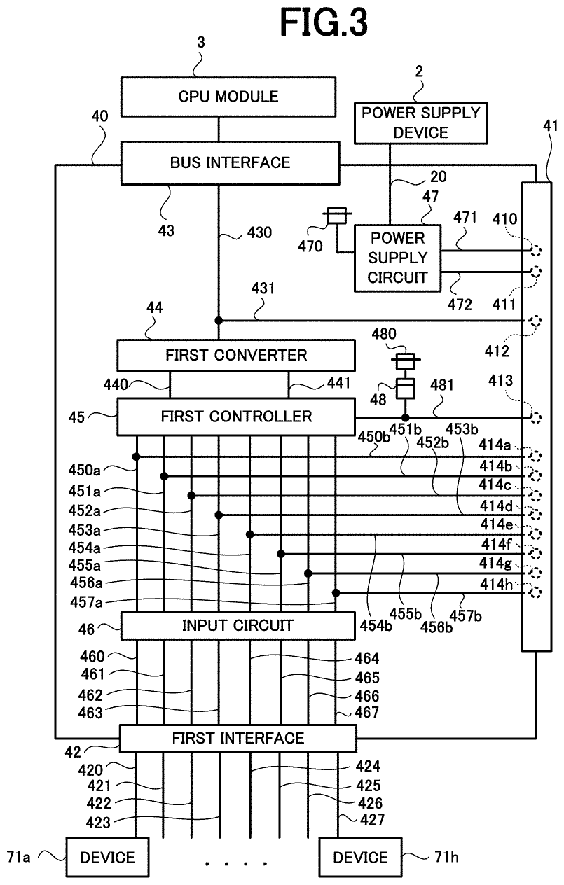

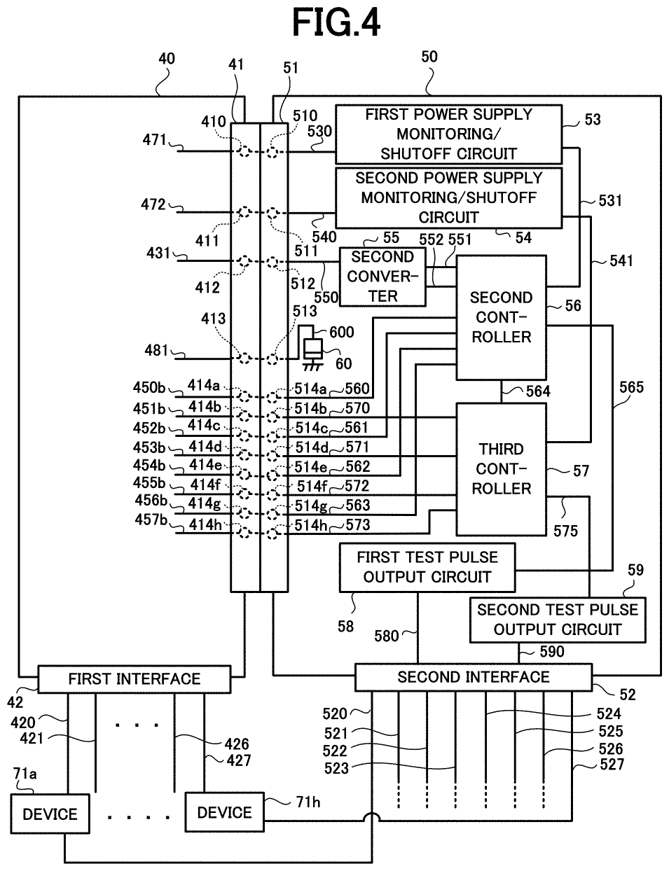

An example configuration of the input standard module unit 40 and the input safety circuit unit 50 is described with standard to FIGS. 3 and 4. FIG. 3 illustrates an example configuration of the input standard module unit 40. The input standard module unit 40 includes the first connector 41 to which the input safety circuit unit 50 is connected, the bus interface 43 for connecting with the CPU module 3, a first converter 44 for converting a signal, a first controller 45 for performing various types of control and converting various data items, an input circuit 46 for transmitting input signals from the devices 71 to the first controller 45, a power supply circuit 47 for changing a voltage supplied from the power supply device 2, and a first operation setting resistor 48 for pulling up the first controller 45.

The first connector 41 includes a first power supply connection contact 410, a second power supply connection contact 411, a first control signal communication contact 412, a first operation setting contact 413, and first safety control contacts 414a to 414h for connecting with the second connector 51 of the input safety circuit unit 50. The first power supply connection contact 410 is a contact for connecting with the power supply circuit 47 with a first power supply joining line 471. The second power supply connection contact 411 is a contact for connecting with the power supply circuit 47 with a second power supply joining line 472.

The first control signal communication contact 412 allows transmission and reception of various data items between the CPU module 3 and the input safety circuit unit 50 through a second data communication signal line 431. The first operation setting contact 413 is connected to the first operation setting resistor 48 with a first operation setting signal line 481. The first safety control contacts 414a to 414h are connection points connected to a second controller 56 and a third controller 57 in the input safety circuit unit 50 described later.

The first power supply connection contact 410, the second power supply connection contact 411, the first control signal communication contact 412, the first operation setting contact 413, and the first safety control contacts 414a to 414h in the first connector 41 may be female pins that can receive the male pins formed on contacts in the second connector 51 described later. The male pins and the female pins may be reversed.

The first interface 42 is used for receiving input signals from the connected devices 71. The first interface 42 is connected with a first input signal transmission line 460, a second input signal transmission line 461, a third input signal transmission line 462, a fourth input signal transmission line 463, a fifth input signal transmission line 464, a sixth input signal transmission line 465, a seventh input signal transmission line 466, and an eighth input signal transmission line 467 used to transmit received input signals to the input circuit 46.

The first input signal transmission line 460 is used to transmit, to the input circuit 46, an input signal received through the first interface 42 from the device 71a to be controlled. The second input signal transmission line 461 is used to transmit, to the input circuit 46, an input signal received through the first interface 42 from the device 71b to be controlled. The third input signal transmission line 462 is used to transmit, to the input circuit 46, an input signal received through the first interface 42 from the device 71c to be controlled. The fourth input signal transmission line 463 is used to transmit, to the input circuit 46, an input signal received through the first interface 42 from the device 71d to be controlled.

The fifth input signal transmission line 464 is used to transmit, to the input circuit 46, an input signal received through the first interface 42 from the device 71e to be controlled. The sixth input signal transmission line 465 is used to transmit, to the input circuit 46, an input signal received through the first interface 42 from the device 71f to be controlled. The seventh input signal transmission line 466 is used to transmit, to the input circuit 46, an input signal received through the first interface 42 from the device 71g to be controlled. The eighth input signal transmission line 467 is used to transmit, to the input circuit 46, an input signal received through the first interface 42 from the device 71h to be controlled.

The bus interface 43 is used for transmitting and receiving various data items to and from the CPU module 3. The bus interface 43 transmits data received from the CPU module 3, such as control data and setting data, to the first converter 44 through a first data communication signal line 430. The bus interface 43 also transmits various data items received from the first converter 44 through the first data communication signal line 430 to the CPU module 3. The bus interface 43 may include an interface that allows data transmission and reception, such as a bus application-specific integrated circuit (ASIC) or a bus connector.

The second data communication signal line 431 has one end connected to the first data communication signal line 430, and the other end connected to the first control signal communication contact 412. The first control signal communication contact 412 is connectable with a second control signal communication contact 512 in the second connector 51 of the input safety circuit unit 50 illustrated in FIG. 2. These connections allow control signals from the CPU module 3 and input signals from the devices 71 to be transmitted to the input safety circuit unit 50. The connections also allow the CPU module 3 to receive various data items transmitted from the input safety circuit unit 50.

The first converter 44 converts the transmission mode of data received from the CPU module 3 through the first data communication signal line 430, such as control data and setting data, to a transmission mode in which the data can be transmitted to the first controller 45. The first converter 44 transmits the converted data to the first controller 45 through a first controlling data signal line 440 and a first controlling address signal line 441. The first converter 44 also converts the transmission mode of data received from the first controller 45 through the first controlling data signal line 440 and the first controlling address signal line 441 to a transmission mode in which the data can be transmitted to the CPU module 3. The first converter 44 transmits the converted data to the bus interface 43 through the first data communication signal line 430. The first converter 44 may include, for example, a serial-parallel conversion integrated circuit (IC) when data can be transmitted to one of the CPU module 3 and the first controller 45 in a serial transmission mode and transmitted to the other in a parallel transmission mode.

The first controller 45 controls the operation of the input standard module unit 40 based on data received from the CPU module 3, such as control data and setting data. The first controller 45 also converts the data format of input signals received from the devices 71 connected to the first interface 42 to a data format supported by the CPU module 3. The first controller 45 transmits the converted data to the first converter 44. The first controller 45 may include, for example, an ASIC for standard input and output control.

The input circuit 46 is a circuit that transmits input signals acquired from the devices 71 connected to the first interface 42 to the first controller 45. The input circuit 46 may include, for example, an input resistor or a photocoupler that provides insulation from the outside.

The first controller 45 and the input circuit 46 are connected together with a first signal reception line 450a, a second signal reception line 451a, a third signal reception line 452a, a fourth signal reception line 453a, a fifth signal reception line 454a, a sixth signal reception line 455a, a seventh signal reception line 456a, and an eighth signal reception line 457a. The first controller 45 receives input signals transmitted from the devices 71a to 71h through the first signal reception line 450a to the eighth signal reception line 457a, respectively.

The first signal reception line 450a, the second signal reception line 451a, the third signal reception line 452a, the fourth signal reception line 453a, the fifth signal reception line 454a, the sixth signal reception line 455a, the seventh signal reception line 456a, and the eighth signal reception line 457a branch and connect to the first safety control contacts 414a to 414h, respectively.

The power supply circuit 47 changes a voltage supplied from the power supply device 2 into a voltage used in the internal circuits of the input standard module unit 40. For example, the voltage supplied from the power supply device 2 may be 24 V, and the voltage used in the internal circuits of the input standard module unit 40 may be 5 V or 3.3 V. In this case, the power supply circuit 47 changes the voltage of 24 V supplied from the power supply device 2 into the voltage of 5 V or 3.3 V used in the internal circuits of the input standard module unit 40.

The power supply circuit 47 includes a driving power supply 470. The power supply circuit 47 is connected to the first power supply connection contact 410 in the first connector 41 with the first power supply joining line 471. The power supply circuit 47 is connected to the second power supply connection contact 411 of the first connector 41 with the second power supply joining line 472.

The first operation setting resistor 48 is used for switching on or off the operation of the first controller 45. The first operation setting resistor 48 includes a pull-up drive power supply 480. The first controller 45 operates when the first operation setting resistor 48 pulls up a specific pin included in the first controller 45.

An example configuration of the input safety circuit unit 50 is described with reference to FIG. 4. The input safety circuit unit 50 includes the second connector 51 for connecting to the input standard module unit 40, the second interface 52 for connecting with the devices 71a to 71h, a first power supply monitoring/shutoff circuit 53 and a second power supply monitoring/shutoff circuit 54 that monitor the power supply circuit 47 illustrated in FIG. 3, a second converter 55 that converts the transmission mode for transmitting and receiving signals to and from the input standard module unit 40, the second controller 56 and the third controller 57 that control the operation of the input standard module unit 40 and diagnose the safety of the input standard module unit 40, a first test pulse output circuit 58 and a second test pulse output circuit 59 that output test pulses, and a second operation setting resistor 60 that sets the operations of the second controller 56 and the third controller 57. The connection of the input safety circuit unit 50 to the input standard module unit 40 allows the combination of the input standard module unit 40 and the input safety circuit unit 50 to operate as a safety reception module. In particular, the input safety circuit unit 50 may have a redundant configuration to satisfy Safety category 4 in ISO 13849-1 that is a safety standard. Thus, in the present embodiment, the two power supply monitoring/shutoff circuits, the two controllers, and the two test pulse output circuits are used to form a redundant structure.

The second connector 51 includes a first power supply monitoring/shutoff contact 510, a second power supply monitoring/shutoff contact 511, the second control signal communication contact 512, a second operation setting contact 513, and second safety control contacts 514a to 514h for connecting with the first connector 41 of the input standard module unit 40.

The first power supply monitoring/shutoff contact 510 is connected to the first power supply monitoring/shutoff circuit 53 with a first power supply monitoring/shutoff signal line 530. The first power supply monitoring/shutoff contact 510 is also connected to the first power supply connection contact 410 in the first connector 41. The second power supply monitoring/shutoff contact 511 is connected to the second power supply monitoring/shutoff circuit 54 with a second power supply monitoring/shutoff signal line 540. The second power supply monitoring/shutoff contact 511 is also connected to the second power supply connection contact 411 in the first connector 41. These connections allow the first power supply monitoring/shutoff circuit 53 and the second power supply monitoring/shutoff circuit 54 to be connected to the power supply circuit 47 illustrated in FIG. 3.

The second control signal communication contact 512 is connected to the second converter 55 with a third data communication line 550. The second operation setting contact 513 is connected to the second operation setting resistor 60 with a first operation setting resistor connection line 600.

The second safety control contacts 514a to 514h each are connected to the second controller 56 or the third controller 57. More specifically, the second safety control contact 514a is connected to the second controller 56 with a first safety signal line 560. The second safety control contact 514b is connected to the third controller 57 with a second safety signal line 570. The second safety control contact 514c is connected to the second controller 56 with a third safety signal line 561. The second safety control contact 514d is connected to the third controller 57 with a fourth safety signal line 571.

The second safety control contact 514e is connected to the second controller 56 with a fifth safety signal line 562. The second safety control contact 514f is connected to the third controller 57 with a sixth safety signal line 572. The second safety control contact 514g is connected to the second controller 56 with a seventh safety signal line 563. The second safety control contact 514h is connected to the third controller 57 with an eighth safety signal line 573.

The first power supply monitoring/shutoff contact 510, the second power supply monitoring/shutoff contact 511, the second control signal communication contact 512, the second operation setting contact 513, and the second safety control contacts 514a to 514h in the second connector 51 may be, for example, male pins insertable into the female pins formed on the contacts in the first connector 41. The male pins and the female pins may be reversed.

The second interface 52 is used for outputting test pulses generated in the first test pulse output circuit 58 or the second test pulse output circuit 59 to the connected devices 71.

The first power supply monitoring/shutoff circuit 53 and the second power supply monitoring/shutoff circuit 54 are circuits that monitor the power supply circuit 47 illustrated in FIG. 3 and shut off the power to the power supply circuit 47 upon a problem. The first power supply monitoring/shutoff circuit 53 is connected to the second controller 56 with a first shutoff instruction signal line 531. The second power supply monitoring/shutoff circuit 54 is connected to the third controller 57 with a second shutoff instruction signal line 541.

The first power supply monitoring/shutoff circuit 53 monitors the power supply circuit 47 illustrated in FIG. 3 and transmits the monitoring results to the second controller 56. The second power supply monitoring/shutoff circuit 54 monitors the power supply circuit 47 and transmits the monitoring results to the third controller 57. When both the received results of monitoring the power supply circuit 47 indicate an abnormality, the second controller 56 and the third controller 57 issue an instruction to shut off the power to the power supply circuit 47 to the first power supply monitoring/shutoff circuit 53 and the second power supply monitoring/shutoff circuit 54. The first power supply monitoring/shutoff circuit 53 and the second power supply monitoring/shutoff circuit 54 shut off the power to the power supply circuit 47 in accordance with the received instruction.

The second converter 55 converts the transmission mode of various data items transmitted and received between the input standard module unit 40 and the second controller 56 to the transmission mode supported by the input standard module unit 40 or the transmission mode supported by the second controller 56. The second converter 55 is connected to the input standard module unit 40 with the third data communication line 550. The second converter 55 is also connected to the second controller 56 with a second controlling data signal line 551 and a second controlling address signal line 552. The second converter 55 may include, for example, a serial-parallel conversion IC when one of the input standard module unit 40 and the second controller 56 uses a serial transmission mode, and the other uses a parallel transmission mode.

The second controller 56 and the third controller 57 control the operation of the input standard module unit 40 and diagnose the safety of the input standard module unit 40. The second controller 56 and the third controller 57 are connected to each other with a control state determination line 564. The second controller 56 determines whether the operation state of the third controller 57 is normal with the control state determination line 564. The third controller 57 determines whether the operation state of the second controller 56 is normal with the control state determination line 564. In this manner, the second controller 56 and the third controller 57 cross-check whether each operation state is normal.

The second controller 56 is connected with the first safety signal line 560 and the second safety control contact 514a to a first signal reception line 450b branching from the first signal reception line 450a illustrated in FIG. 3. Beyond the first signal reception line 450b, the control target device 71a illustrated in FIG. 3 is connected. The second controller 56 is connected with the third safety signal line 561 and the second safety control contact 514c to a third signal reception line 452b branching from the third signal reception line 452a illustrated in FIG. 3. Beyond the third signal reception line 452b, the control target device 71c illustrated in FIG. 3 is connected.

The second controller 56 is connected with the fifth safety signal line 562 and the second safety control contact 514e to a fifth signal reception line 454b branching from the fifth signal reception line 454a illustrated in FIG. 3. Beyond the fifth signal reception line 454b, the control target device 71e illustrated in FIG. 3 is connected. The second controller 56 is connected with the seventh safety signal line 563 and the second safety control contact 514g to a seventh signal reception line 456b branching from the seventh signal reception line 456a illustrated in FIG. 3. Beyond the seventh signal reception line 456b, the control target device 71g illustrated in FIG. 3 is connected.

The third controller 57 is connected with the second safety signal line 570 and the second safety control contact 514b to a second signal reception line 451b branching from the second signal reception line 451a illustrated in FIG. 3. Beyond the second signal reception line 451b, the control target device 71b illustrated in FIG. 3 is connected. The third controller 57 is connected with the fourth safety signal line 571 and the second safety control contact 514d to a fourth signal reception line 453b branching from the fourth signal reception line 453a illustrated in FIG. 3. Beyond the fourth signal reception line 453b, the control target device 71d illustrated in FIG. 3 is connected.

The third controller 57 is connected with the sixth safety signal line 572 and the second safety control contact 514f to a sixth signal reception line 455b branching from the sixth signal reception line 455a illustrated in FIG. 3. Beyond the sixth signal reception line 455b, the control target device 71f illustrated in FIG. 3 is connected. The third controller 57 is connected with the eighth safety signal line 573 and the second safety control contact 514h to an eighth signal reception line 457b branching from the eighth signal reception line 457a illustrated in FIG. 3. Beyond the eighth signal reception line 457b, the control target device 71h illustrated in FIG. 3 is connected.

The second controller 56 thus receives input signals from the control target devices 71a, 71c, 71e, and 71g illustrated in FIG. 3. The third controller 57 receives input signals from the control target devices 71b, 71d, 71e, and 71h illustrated in FIG. 3. Each input signal from the devices 71a to 71h may be received by both the second controller 56 and the third controller 57. In this case, each device 71 has duplication wiring. More specifically, the first input signal line 420, the first input signal transmission line 460, the first signal reception line 450a, and the first safety signal line 560 for transmitting an input signal from the device 71a each are duplicated. A second signal reception line 450b is branched from the first one of the first signal reception lines 450a and routed to allow an input signal from the device 71a to be input into the second controller 56 through one first safety signal line 560. Additionally, another second signal reception line is branched from the second one of the first signal reception lines (not illustrated). The second one of the second signal reception lines is a route along which an input signal from the device 71a is input into the third controller 57 through the second one of the first safety signal lines. The duplication wiring is provided in this manner. Similarly, the devices 71b to 71h may have duplication wiring.

The first test pulse output circuit 58 is controlled by the second controller 56 to generate and output a test pulse. The first test pulse output circuit 58 is connected to the second controller 56 with a first test pulse instruction signal line 565. The first test pulse output circuit 58 transmits test pulses through the second interface 52 to the devices 71a, 71c, 71e, and 71g connected to the first diagnosis line 520, the third diagnosis line 522, the fifth diagnosis line 524, and the seventh diagnosis line 526, respectively. The second controller 56 can thus diagnose a failure in the devices 71a, 71c, 71e, and 71g as well as the channels for transmitting input signals from the devices 71a, 71c, 71e, and 71g to the second controller 56. For devices 71 each having duplication wiring, the first diagnosis line 520, the third diagnosis line 522, the fifth diagnosis line 524, and the seventh diagnosis line 526 each are duplicated. The first one of the first diagnosis lines 520, the first one of the third diagnosis lines 522, the first one of the fifth diagnosis lines 524, and the first one of the seventh diagnosis lines 526 are connected to the devices 71a, 71c, 71e, and 71g, respectively. The second one of the first diagnosis lines, the second one of the third diagnosis lines, the second one of the fifth diagnosis lines, and the second one of the seventh diagnosis lines (not illustrated) are connected to the devices 71b, 71d, 71f, and 71h, respectively. The duplication wiring provided in this manner may be used to transmit test pulses from the first test pulse output circuit 58 to the devices 71a to 71h.

The second test pulse output circuit 59 is controlled by the third controller 57 to generate and output a test pulse. The second test pulse output circuit 59 is connected to the third controller 57 with a second test pulse instruction signal line 575. The second test pulse output circuit 59 transmits test pulses through the second interface 52 to the devices 71b, 71d, 71f, and 71h connected to the second diagnosis line 521, the fourth diagnosis line 523, the sixth diagnosis line 525, and the eighth diagnosis line 527, respectively. The third controller 57 can thus diagnose a failure in the devices 71b, 71d, 71f, and 71h as well as the channels for transmitting input signals from the devices 71b, 71d, 71f, and 71h to the third controller 57. As described above, for devices 71 each having duplication wiring, the second diagnosis line 521, the fourth diagnosis line 523, the sixth diagnosis line 525, and the eighth diagnosis line 527 each are duplicated. The first one of the second diagnosis lines 521, the first one of the fourth diagnosis lines 523, the first one of the sixth diagnosis lines 525, and the first one of the eighth diagnosis lines 527 are connected, as described above, to the devices 71b, 71d, 71f, and 71h, respectively. The second one of the second diagnosis lines, the second one of the fourth diagnosis lines, the second one of the sixth diagnosis lines, and the second one of the eighth diagnosis lines (not illustrated) are connected to the devices 71a, 71c, 71e, and 71g, respectively. The duplication wiring provided in this manner may be used to transmit test pulses from the second test pulse output circuit 59 to the devices 71a to 71h.

For example, with the second controller 56 and the third controller 57 outputting ON diagnosis signals, the first test pulse output circuit 58 and the second test pulse output circuit 59 output OFF test pulses to the devices 71a to 71h. When the devices 71a to 71h each output an OFF signal upon the test pulses, the second controller 56 and the third controller 57 determine the absence of a failure in the devices 71a to 71h as well as the channels for transmitting input signals from the devices 71a to 71h to the second controller 56 and the third controller 57. In contrast, when any of the devices 71a to 71h outputs an ON signal instead of an OFF signal, the second controller 56 and the third controller 57 determine the presence of a failure in the devices 71 outputting the ON signal or the channel for transmitting input signals from the devices 71 to the second controller 56 and the third controller 57.

The second operation setting resistor 60 is used for switching on or off the operation of the first controller 45. More specifically, when the second connector 51 is connected to the first connector 41 of the input standard module unit 40, the second operation setting resistor 60 pulls down the specific pin in the first controller 45 illustrated in FIG. 3. This opens all the connections between the first controller 45 and the first signal reception line 450a to the eighth signal reception line 457a. Thus, input signals from the devices 71 are no longer input into the first controller 45.

Input signals from the devices 71 are transmitted to the second controller 56 and the third controller 57 through the first interface 42, the input circuit 46 illustrated in FIG. 3, the first connector 41, and the second connector 51. The input signals received from the devices 71 are then converted at the second converter 55 and transmitted through the first connector 41 and the second connector 51 to the bus interface 43 illustrated in FIG. 3. The bus interface 43 transmits the input signals received from the devices 71 to the CPU module 3 illustrated in FIG. 3.

The above configuration allows the input safety circuit unit 50 connected to the input standard module unit 40 to serve as a safety reception module including the combination of the input standard module unit 40 and the input safety circuit unit 50 and transmit input signals received from the devices 71 to the CPU module 3. In addition, the input safety circuit unit 50 can diagnose a failure in the power supply circuit 47 illustrated in FIG. 3 and the devices 71 as well as the contacts in the second interface 52. In this manner, the connection of the input safety circuit unit 50 to the input standard module unit 40 allows the combination of the input standard module unit 40 and the input safety circuit unit 50 to operate as a safety reception module for conducting various diagnoses.

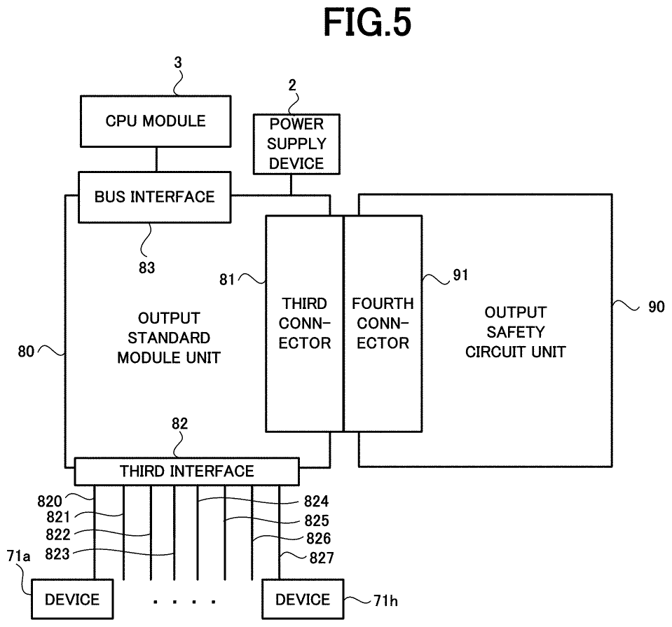

A specific configuration of the output standard module unit 80 and the output safety circuit unit 90 is described. The configuration of the output standard module unit 80 and the output safety circuit unit 90 is schematically illustrated in FIG. 5. The output standard module unit 80 includes the third connector 81 to which the output safety circuit unit 90 is connected with the fourth connector 91, and a bus interface 83 for transmitting and receiving various data items to and from the CPU module 3. The output standard module unit 80 receives a voltage from the power supply device 2.

The third interface 82 of the output standard module unit 80 is connected with a first output signal line 820, a second output signal line 821, a third output signal line 822, a fourth output signal line 823, a fifth output signal line 824, a sixth output signal line 825, a seventh output signal line 826, and an eighth output signal line 827. The first output signal line 820 is used to output an output signal from the output standard module unit 80 through the third interface 82 to the device 71a to be controlled. The second output signal line 821 is used to output an output signal from the output standard module unit 80 through the third interface 82 to the device 71b to be controlled.

The third output signal line 822 is used to output an output signal from the output standard module unit 80 through the third interface 82 to the device 71c to be controlled. The fourth output signal line 823 is used to output an output signal from the output standard module unit 80 through the third interface 82 to the device 71d to be controlled. The fifth output signal line 824 is used to output an output signal from the output standard module unit 80 through the third interface 82 to the device 71e to be controlled.

The sixth output signal line 825 is used to output an output signal from the output standard module unit 80 through the third interface 82 to the device 71f to be controlled. The seventh output signal line 826 is used to output an output signal from the output standard module unit 80 through the third interface 82 to the device 71g to be controlled. The eighth output signal line 827 is used to output an output signal from the output standard module unit 80 through the third interface 82 to the device 71h to be controlled. The first interface 42 illustrated in FIG. 3 and the third interface 82 are examples of an external interface in the claims.

The output safety circuit unit 90 includes the fourth connector 91 for connecting with the output standard module unit 80. The output safety circuit unit 90 can diagnose the operation state of the output standard module unit 80 and also the operation states of the devices 71.

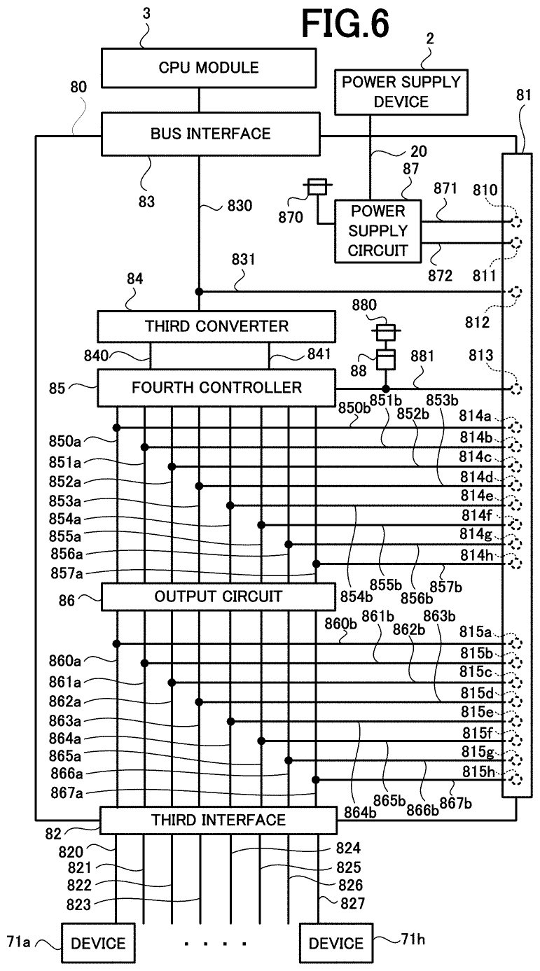

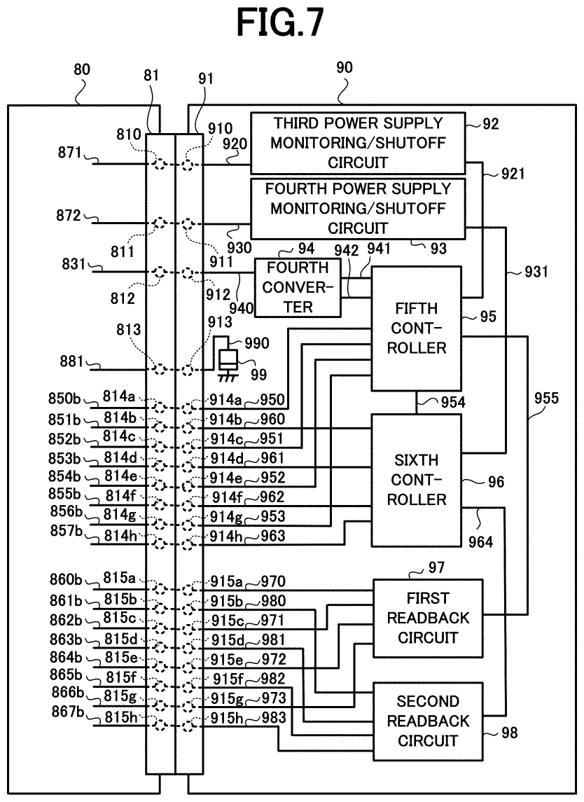

An example configuration of the output standard module unit 80 and the output safety circuit unit 90 is described with reference to FIGS. 6 and 7. FIG. 6 illustrates an example configuration of the output standard module unit 80. The output standard module unit 80 includes the third connector 81 to which the output safety circuit unit 90 is connected, the bus interface 83 for connecting with the CPU module 3, a third converter 84 for converting a signal, a fourth controller 85 for performing various types of control and converting various data items, an output circuit 86 for transmitting output signals from the fourth controller 85 to the devices 71, a power supply circuit 87 for changing a voltage supplied from the power supply device 2, and a third operation setting resistor 88 for pulling up the fourth controller 85.

The third connector 81 includes a third power supply connection contact 810, a fourth power supply connection contact 811, a third control signal communication contact 812, a fourth operation setting contact 813, third safety control contacts 814a to 814h, and first readback contacts 815a to 815h for connecting with the fourth connector 91 of the output safety circuit unit 90. The third power supply connection contact 810 is a contact for connecting with the power supply circuit 87 with a third power supply joining line 871. The fourth power supply connection contact 811 is a contact for connecting with the power supply circuit 47 with a fourth power supply joining line 872.

The third control signal communication contact 812 allows transmission and reception of various data items between the CPU module 3 and the output safety circuit unit 90 through a fifth data communication signal line 831. The fourth operation setting contact 813 is connected to the third operation setting resistor 88 with a second operation setting signal line 881. The third safety control contacts 814a to 814h are connection points connected to a fifth controller 95 and a sixth controller 96 in the output safety circuit unit 90 described later. The first readback contacts 815a to 815h are connection points connected to a first readback circuit 97 or a second readback circuit 98 in the output safety circuit unit 90 described later.

The third power supply connection contact 810, the fourth power supply connection contact 811, the third control signal communication contact 812, the fourth operation setting contact 813, the third safety control contacts 814a to 814h, and the first readback contacts 815a to 815h in the third connector 81 may be female pins that can receive the male pins formed on contacts in the fourth connector 91 described later. The male pins and the female pins may be reversed. The first connector 41 illustrated in FIG. 3 and the third connector 81 are examples of a first connector in the claims.

The third interface 82 is used for transmitting output signals received from the CPU module 3 to the devices 71. The third interface 82 is connected to the output circuit 86 with a first output signal transmission line 860a, a second output signal transmission line 861a, a third output signal transmission line 862a, a fourth output signal transmission line 863a, a fifth output signal transmission line 864a, a sixth output signal transmission line 865a, a seventh output signal transmission line 866a, and an eighth output signal transmission line 867a.

The first output signal transmission line 860a is used to transmit an output signal received from the CPU module 3 to the device 71a through the third interface 82. The second output signal transmission line 861a is used to transmit an output signal received from the CPU module 3 to the device 71b through the third interface 82. The third output signal transmission line 862a is used to transmit an output signal received from the CPU module 3 to the device 71c through the third interface 82. The fourth output signal transmission line 863a is used to transmit an output signal received from the CPU module 3 to the device 71d through the third interface 82.

The fifth output signal transmission line 864a is used to transmit an output signal received from the CPU module 3 to the device 71e through the third interface 82. The sixth output signal transmission line 865a is used to transmit an output signal received from the CPU module 3 to the device 71f through the third interface 82. The seventh output signal transmission line 866a is used to transmit an output signal received from the CPU module 3 to the device 71g through the third interface 82. The eighth output signal transmission line 867a is used to transmit an output signal received from the CPU module 3 to the device 71h through the third interface 82.

The first output signal transmission line 860a to the eighth output signal transmission line 867a branch respectively into a first output signal transmission line 860b to an eighth output signal transmission line 867b. The first output signal transmission line 860b to the eighth output signal transmission line 867b that are the branches are connected to the first readback contacts 815a to 815h, respectively.

The bus interface 83 is used for transmitting and receiving various data items to and from the CPU module 3. The bus interface 83 transmits data received from the CPU module 3, such as control data and setting data, to the third converter 84 through a fourth data communication signal line 830. The bus interface 83 may include an interface that allows data transmission and reception, such as a bus ASIC or a bus connector.

The fifth data communication signal line 831 has one end connected to the fourth data communication signal line 830, and the other end connected to the third control signal communication contact 812. The third control signal communication contact 812 is connectable with a fourth control signal communication contact 912 in the fourth connector 91 of the output safety circuit unit 90 illustrated in FIG. 7. These connections allow control signals from the CPU module 3 to be transmitted to the output safety circuit unit 90.

The third converter 84 converts the transmission mode of data received from the CPU module 3 through the fourth data communication signal line 830, such as control data and setting data, to a transmission mode in which the data can be transmitted to the fourth controller 85. The third converter 84 transmits the converted data to the fourth controller 85 through a third controlling data signal line 840 and a third controlling address signal line 841. The third converter 84 also converts the transmission mode of data received from the fourth controller 85 through the third controlling data signal line 840 and the third controlling address signal line 841 to a transmission mode in which the data can be transmitted to the CPU module 3. The third converter 84 transmits the converted data to the bus interface 83 through the fourth data communication signal line 830. The third converter 84 may include, for example, a serial-parallel conversion IC when data can be transmitted to one of the CPU module 3 and the fourth controller 85 in a serial transmission mode and transmitted to the other in a parallel transmission mode.

The fourth controller 85 controls the operation of the output standard module unit 80 based on data received from the CPU module 3 through the third converter 84, such as control data and setting data. The fourth controller 85 also converts the data format of control signals received from the CPU module 3 to a data format in which the signals can be output to the devices 71 connected to the third interface 82. The fourth controller 85 may include, for example, an ASIC for standard input and output control. The first controller 45 illustrated in FIG. 3 and the fourth controller 85 are examples of a standard input/output module controller in the claims.

The output circuit 86 outputs control signals received from the CPU module 3 to the devices 71 through the third interface 82. The output circuit 86 may include, for example, an output transistor or a photocoupler that provides insulation from the outside.

The fourth controller 85 and the output circuit 86 are connected together with a first signal transmission line 850a, a second signal transmission line 851a, a third signal transmission line 852a, a fourth signal transmission line 853a, a fifth signal transmission line 854a, a sixth signal transmission line 855a, a seventh signal transmission line 856a, and an eighth signal transmission line 857a. The fourth controller 85 transmits output signals to the devices 71a to 71h through the first signal transmission line 850a to the eighth signal transmission line 857a.

The first signal transmission line 850a, the second signal transmission line 851a, the third signal transmission line 852a, the fourth signal transmission line 853a, the fifth signal transmission line 854a, the sixth signal transmission line 855a, the seventh signal transmission line 856a, and the eighth signal transmission line 857a branch and connect to the third safety control contacts 814a to 814h, respectively.

The power supply circuit 87 changes a voltage supplied from the power supply device 2 into a voltage used in the internal circuits of the output standard module unit 80. For example, the voltage supplied from the power supply device 2 may be 24 V, and the voltage used in the internal circuits of the output standard module unit 80 may be 5 V or 3.3 V. In this case, the power supply circuit 87 changes the voltage of 24 V supplied from the power supply device 2 into the voltage of 5 V or 3.3 V used in the internal circuits of the output standard module unit 80.

The power supply circuit 87 includes a driving power supply 870. The power supply circuit 87 is connected to the third power supply connection contact 810 in the third connector 81 with the third power supply joining line 871. The power supply circuit 87 is connected to the fourth power supply connection contact 811 of the third connector 81 with the fourth power supply joining line 872.

The third operation setting resistor 88 is used for switching on or off the operation of the fourth controller 85. The third operation setting resistor 88 includes a pull-up drive power supply 880. The fourth controller 85 operates when the third operation setting resistor 88 pulls up a specific pin included in the fourth controller 85. The first operation setting resistor 48 illustrated in FIG. 3 and the third operation setting resistor 88 illustrated in FIG. 6 are examples of a first operation setter in the claims.

An example configuration of the output safety circuit unit 90 is described with reference to FIG. 7. The output safety circuit unit 90 includes the fourth connector 91 for connecting to the output standard module unit 80, a third power supply monitoring/shutoff circuit 92 and a fourth power supply monitoring/shutoff circuit 93 that monitor the power supply circuit 87 illustrated in FIG. 6, a fourth converter 94 that converts the transmission mode for transmitting and receiving signals to and from the output standard module unit 80, the fifth controller 95 and the sixth controller 96 that control the operation of the output standard module unit 80 and diagnose the safety of the output standard module unit 80, the first readback circuit 97 and the second readback circuit 98 that read back a signal, and a fourth operation setting resistor 99. The second operation setting resistor 60 illustrated in FIG. 4 and the fourth operation setting resistor 99 illustrated in FIG. 7 are examples of a second operation setter in the claims.

The connection of the output safety circuit unit 90 to the output standard module unit 80 allows the combination of the output standard module unit 80 and the output safety circuit unit 90 to operate as a safety output module. In particular, the output safety circuit unit 90 may have a redundant configuration to satisfy Safety category 4 in ISO 13849-1 that is a safety standard. Thus, in the present embodiment, the two power supply monitoring/shutoff circuits, the two controllers, and the two readback circuit are used to form a redundant structure.

The first power supply monitoring/shutoff circuit 53, the second power supply monitoring/shutoff circuit 54, the first test pulse output circuit 58, and the second test pulse output circuit 59 illustrated in FIG. 4 and the third power supply monitoring/shutoff circuit 92, the fourth power supply monitoring/shutoff circuit 93, the first readback circuit 97, and the second readback circuit 98 illustrated in FIG. 7 are examples of a diagnoser in the claims. The second controller 56 and the third controller 57 illustrated in FIG. 4 and the fifth controller 95 and the sixth controller 96 illustrated in FIG. 7 are examples of a safety circuit controller in the claims.

The fourth connector 91 includes a third power supply monitoring/shutoff contact 910, a fourth power supply monitoring/shutoff contact 911, the fourth control signal communication contact 912, a fourth operation setting contact 913, fourth safety control contacts 914a to 914h, and second readback contacts 915a to 915h for connecting with the third connector 81 of the output standard module unit 80.

The third power supply monitoring/shutoff contact 910 is connected to the third power supply monitoring/shutoff circuit 92 with a third power supply monitoring/shutoff signal line 920. The third power supply monitoring/shutoff contact 910 is also connected to the third power supply connection contact 810 in the third connector 81. The fourth power supply monitoring/shutoff contact 911 is connected to the fourth power supply monitoring/shutoff circuit 93 with a fourth power supply monitoring/shutoff signal line 930. The fourth power supply monitoring/shutoff contact 911 is also connected to the fourth power supply connection contact 811 in the third connector 81. These connections allow the third power supply monitoring/shutoff circuit 92 and the fourth power supply monitoring/shutoff circuit 93 to be connected to the power supply circuit 87 illustrated in FIG. 6.

The fourth control signal communication contact 912 is connected to the fourth converter 94 with a sixth data communication line 940. The fourth operation setting contact 913 is connected to the fourth operation setting resistor 99 with a second operation setting resistor connection line 990.

The third safety control contacts 814a to 814h each are connected to the fifth controller 95 or the sixth controller 96. More specifically, the third safety control contact 814a is connected to the fifth controller 95 with a first diagnosis control signal line 950. The third safety control contact 814b is connected to the sixth controller 96 with a second diagnosis control signal line 960. The third safety control contact 814c is connected to the fifth controller 95 with a third diagnosis control signal line 951. The third safety control contact 814d is connected to the sixth controller 96 with a fourth diagnosis control signal line 961.

The third safety control contact 814e is connected to the fifth controller 95 with a fifth diagnosis control signal line 952. The third safety control contact 814f is connected to the sixth controller 96 with a sixth diagnosis control signal line 962. The third safety control contact 814g is connected to the fifth controller 95 with a seventh diagnosis control signal line 953. The third safety control contact 814h is connected to the sixth controller 96 with an eighth diagnosis control signal line 963.

The third power supply monitoring/shutoff contact 910, the fourth power supply monitoring/shutoff contact 911, the fourth control signal communication contact 912, the fourth operation setting contact 913, the fourth safety control contacts 914a to 914h, and the second readback contacts 915a to 915h in the fourth connector 91 may be, for example, male pins insertable into the female pins formed on the contacts in the third connector 81. The male pins and the female pins may be reversed. The second connector 51 illustrated in FIG. 3 and the fourth connector 91 illustrated in FIG. 7 are examples of a second connector in the claims.

The third power supply monitoring/shutoff circuit 92 and the fourth power supply monitoring/shutoff circuit 93 are circuits that monitor the power supply circuit 87 illustrated in FIG. 6 and shut off the power to the power supply circuit 87 upon a problem. The third power supply monitoring/shutoff circuit 92 is connected to the fifth controller 95 with a third shutoff instruction signal line 921. The fourth power supply monitoring/shutoff circuit 93 is connected to the sixth controller 96 with a fourth shutoff instruction signal line 931.

The third power supply monitoring/shutoff circuit 92 monitors the power supply circuit 87 illustrated in FIG. 6 and transmits the monitoring results to the fifth controller 95. The fourth power supply monitoring/shutoff circuit 93 monitors the power supply circuit 87 and transmits the monitoring results to the sixth controller 96. When both the received results of monitoring the power supply circuit 87 indicate an abnormality, the fifth controller 95 and the sixth controller 96 transmit an instruction to shut off the power to the power supply circuit 87 to the third power supply monitoring/shutoff circuit 92 and the fourth power supply monitoring/shutoff circuit 93. The third power supply monitoring/shutoff circuit 92 and the fourth power supply monitoring/shutoff circuit 93 shut off the power to the power supply circuit 87 in accordance with the received instruction.

The fourth converter 94 converts the transmission mode of various data items transmitted and received between the output standard module unit 80 and the fifth controller 95 to the transmission mode supported by the output standard module unit 80 or the transmission mode supported by the fifth controller 95. The fourth converter 94 is connected to the output standard module unit 80 with the sixth data communication line 940. The fourth converter 94 is also connected to the fifth controller 95 with a fourth controlling data signal line 941 and a fourth controlling address signal line 942. The fourth converter 94 may include, for example, a serial-parallel conversion IC when one of the output standard module unit 80 and the fifth controller 95 uses a serial transmission mode, and the other uses a parallel transmission mode.

The fifth controller 95 and the sixth controller 96 control the operation of the output standard module unit 80 and diagnose the safety of. The fifth controller 95 and the sixth controller 96 are connected to each other with a control state determination line 954. The fifth controller 95 determines whether the operation state of the sixth controller 96 is normal with the control state determination line 954. The sixth controller 96 determines whether the operation state of the fifth controller 95 is normal with the control state determination line 954. In this manner, the fifth controller 95 and the sixth controller 96 cross-check whether each operation state is normal.

The fifth controller 95 is connected with the first diagnosis control signal line 950 and the fourth safety control contact 914a to a first signal transmission line 850b branching from the first signal transmission line 850a illustrated in FIG. 6. Beyond the first signal transmission line 850b, the control target device 71a illustrated in FIG. 6 is connected. The fifth controller 95 is connected with the third diagnosis control signal line 951 and the fourth safety control contact 914c to a third signal transmission line 852b branching from the third signal transmission line 852a illustrated in FIG. 6. Beyond the third signal transmission line 852b, the control target device 71c illustrated in FIG. 6 is connected.

The fifth controller 95 is connected with the fifth diagnosis control signal line 952 and the fourth safety control contact 914e to a fifth signal transmission line 854b branching from the fifth signal transmission line 854a illustrated in FIG. 6. Beyond the fifth signal transmission line 854b, the control target device 71e illustrated in FIG. 6 is connected. The fifth controller 95 is connected with the seventh diagnosis control signal line 953 and the fourth safety control contact 914g to a seventh signal transmission line 856b branching from the seventh signal transmission line 856a illustrated in FIG. 6. Beyond the seventh signal transmission line 856b, the control target device 71g illustrated in FIG. 6 is connected.

The sixth controller 96 is connected with the second diagnosis control signal line 960 and the fourth safety control contact 914b to a second signal transmission line 851b branching from the second signal transmission line 851a illustrated in FIG. 6. Beyond the second signal transmission line 851b, the control target device 71b illustrated in FIG. 6 is connected. The sixth controller 96 is connected with the fourth diagnosis control signal line 961 and the fourth safety control contact 914d to a fourth signal transmission line 853b branching from the fourth signal transmission line 853a illustrated in FIG. 6. Beyond the fourth signal transmission line 853b, the control target device 71d illustrated in FIG. 6 is connected.

The sixth controller 96 is connected with the sixth diagnosis control signal line 962 and the fourth safety control contact 914f to a sixth signal transmission line 855b branching from the sixth signal transmission line 855a illustrated in FIG. 6. Beyond the sixth signal transmission line 855b, the control target device 71f illustrated in FIG. 6 is connected. The sixth controller 96 is connected with the eighth diagnosis control signal line 963 and the fourth safety control contact 914h to an eighth signal transmission line 857b branching from the eighth signal transmission line 857a illustrated in FIG. 6. Beyond the eighth signal transmission line 857b, the control target device 71h illustrated in FIG. 6 is connected.

The fifth controller 95 thus transmits output signals to the control target devices 71a, 71c, 71e, and 71g illustrated in FIG. 6. The sixth controller 96 transmits output signals to the control target devices 71b, 71d, 71e, and 71h illustrated in FIG. 6.

The first readback circuit 97 is connected to the fifth controller 95 with a first readback circuit connection line 955. The first readback circuit 97 is also connected with a first readback signal line 970 and the second readback contact 915a to the first output signal transmission line 860b branching from the first output signal transmission line 860a illustrated in FIG. 6. The first readback circuit 97 is connected with a second readback signal line 971 and the second readback contact 915c to the third output signal transmission line 862b branching from the third output signal transmission line 862a illustrated in FIG. 6.

The first readback circuit 97 is connected with a third readback signal line 972 and the second readback contact 915e to the fifth output signal transmission line 864b branching from the fifth output signal transmission line 864a illustrated in FIG. 6. The first readback circuit 97 is connected with a fourth readback signal line 973 and the second readback contact 915g to the third output signal transmission line 866b branching from the seventh output signal transmission line 866a illustrated in FIG. 6. The first readback circuit 97 reads back output signals from the fifth controller 95 through the first readback signal line 970, the second readback signal line 971, the third readback signal line 972, and the fourth readback signal line 973 and diagnoses the output signals.

The second readback circuit 98 is connected to the sixth controller 96 with a second readback circuit connection line 946. The second readback circuit 98 is also connected with a fifth readback signal line 980 and the second readback contact 915b to the second output signal transmission line 861b branching from the second output signal transmission line 861a illustrated in FIG. 6. The second readback circuit 98 is connected with a sixth readback signal line 981 and the second readback contact 915d to the fourth output signal transmission line 863b branching from the fourth output signal transmission line 863a illustrated in FIG. 6. The second readback circuit 98 is connected with a seventh readback signal line 982 and the second readback contact 915f to the sixth output signal transmission line 865b branching from the sixth output signal transmission line 865a illustrated in FIG. 6. The second readback circuit 98 is connected with an eighth readback signal line 983 and the second readback contact 915h to the eighth output signal transmission line 867b branching from the eighth output signal transmission line 867a illustrated in FIG. 6.

The second readback circuit 98 reads back output signals from the sixth controller 96 through the fifth readback signal line 980, the sixth readback signal line 981, the seventh readback signal line 982, and the eighth readback signal line 983 and diagnoses the output signals. The first readback circuit 97 and the second readback circuit 98 read back and diagnose output signals from the fifth controller 95 and the sixth controller 96. The first readback circuit 97 and the second readback circuit 98 transmit the diagnosis results to the fifth controller 95 and the sixth controller 96. Without any abnormality in the received diagnosis results, the fifth controller 95 and the sixth controller 96 continue the processing. With an abnormality in the received diagnosis results, the fifth controller 95 and the sixth controller 96 informs the CPU module 3 about the abnormality.

Both the fifth controller 95 and the sixth controller 96 may transmit an output signal to each of the devices 71a to 71h. In this case, each device 71 has duplication wiring. More specifically, the first signal transmission line 850a, the first output signal transmission line 860a, the first output signal line 820, and the first diagnosis control signal line 950 for transmitting an output signal to the device 71a, and the first readback signal line 970 and the first readback circuit connection line 955 for reading back an output signal each are duplicated. One first signal transmission line 850b is first branched from the first one of the first signal transmission lines 850a. The branch is then routed to allow an output signal from the fifth controller 95 to be output to the device 71a through a first diagnosis control signal line 950, the first signal transmission lines 850a and 850b, a first output signal transmission line 860a, and a first output signal line 820.

Another first signal transmission line is then branched from the second one of the first signal transmission lines (not illustrated). The branch is then routed to allow an output signal from the sixth controller 96 to be output to the device 71a through the second one of the first diagnosis control signal lines, the first signal transmission lines, the second one of the first output signal transmission lines, and the second one of the first output signal lines. Additionally, one first output signal transmission line 860b is branched from the first one of the first output signal transmission lines 860a. The lines are routed to allow an output signal from the fifth controller 95 to be input into the first readback circuit 97 through one first readback signal line 970. The lines are routed to allow an output from the first readback circuit 97 to be input into the fifth controller 95 through the first one of the first readback circuit connection lines 955.

Another first output signal transmission line is branched from the second one of the first output signal transmission lines (not illustrated). The lines are routed to allow an output signal from the sixth controller 96 to be input into the first readback circuit 97 through the second one of the first readback signal lines. The lines are routed to allow an output from the first readback circuit 97 to be input into the sixth controller 96 through the second one of the first readback circuit connection lines. This routing achieves duplication wiring. The devices 71b to 71h may similarly have duplication wiring. The second ones of the lines described above are not illustrated.

The fourth operation setting resistor 99 is used for switching on or off the operation of the fifth controller 95 and the sixth controller 96. More specifically, when the fourth connector 91 is connected to the third connector 81 of the output standard module unit 80, the fourth operation setting resistor 99 and the second operation setting resistor 60 pull down the specific pin in the fourth controller 85 illustrated in FIG. 6. This opens all the connections between the fourth controller 85 and the first signal transmission line 850a to the eighth signal transmission line 857a. Thus, control signals from the CPU module 3 are no longer output from the fourth controller 85 to the devices 71.

Control signals output from the CPU module 3 are transmitted to the fifth controller 95 and the sixth controller 96 through the fifth data communication signal line 831, the third connector 81, the fourth connector 91, and the fourth converter 94. The control signals are then output from the fifth controller 95 to the devices 71a, 71c, 71e, and 71g through the third connector 81 and the fourth connector 91. The control signals are also output from the sixth controller 96 to the devices 71b, 71d, 71e, and 71h through the third connector 81 and the fourth connector 91.

The above configuration allows the output safety circuit unit 90 connected to the output standard module unit 80 to serve as a safety output module including the combination of the output standard module unit 80 and the output safety circuit unit 90 and output control signals from the CPU module 3 to the devices 71. In addition, the output safety circuit unit 90 can diagnose the power supply circuit 87 and the devices 71 illustrated in FIG. 6. In this manner, the connection of the output safety circuit unit 90 to the output standard module unit 80 allows the combination of the output standard module unit 80 and the output safety circuit unit 90 to operate as a safety output module for conducting various diagnoses.

As described above, the input/output module 100 according to the embodiment allows the safety circuit unit 5 to be removably inserted into the standard input/output module unit 4, and the removable insertion allows switching as appropriate between the operation of a standard input/output module and the operation of a safety input/output module including a diagnosis circuit for each circuit block. The switching allows the standard input/output module unit 4 to operate singly as a standard input/output module, thus reducing the waste of power compared with the operation of a safety input/output module as a standard input/output module.

In the embodiment, the standard input/output module unit 4 and the safety circuit unit 5 are separate units. Upon a failure of the standard input/output module unit 4, the safety circuit unit 5 may still be usable by replacing the standard input/output module unit 4. Conversely, upon a failure of the safety circuit unit 5, the standard input/output module unit 4 may still be usable by replacing the safety circuit unit 5. This reduces the waste of components.

Modification 1

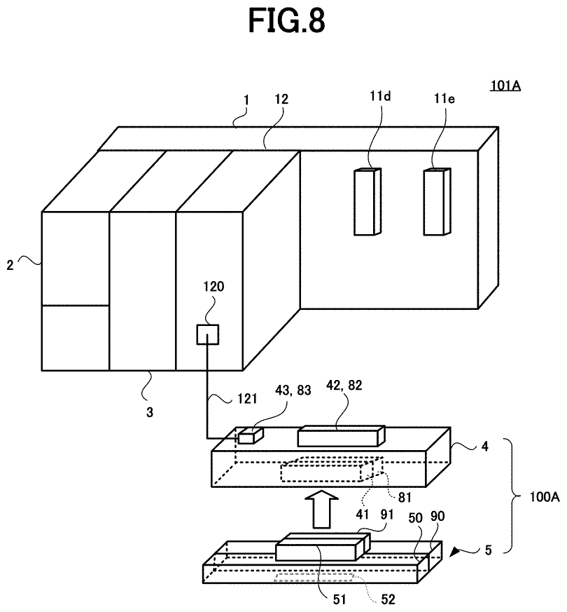

In the above embodiment, the input/output module 100 is connected to the PLC 101 with the couplers 11 on the base 1 of the PLC 101 illustrated in FIG. 1. However, the connection may be changed, for example, as illustrated in FIG. 8. FIG. 8 illustrates a PLC 101A connected with a network interface 12. The network interface 12 includes a network connector 120. An input/output module 100A includes bus interfaces 43 and 83 connected to the network connector 120 with a network cable 121. This connection provides the remote input/output module 100A.

Modification 2

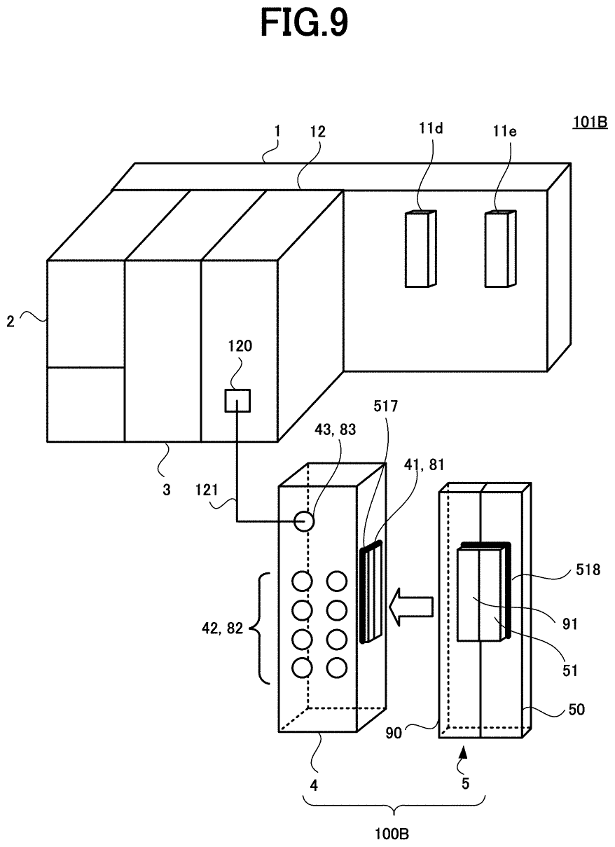

The input/output modules 100 and 100A according to the above embodiment and modification may be accommodated in a waterproof housing. An example is illustrated in FIG. 9. The standard input/output module unit 4 and the safety circuit unit 5 each are accommodated in a waterproof housing. An elastic gasket 517 is attached to the first connector 41 and the third connector 81 of the standard input/output module unit 4. An elastic gasket 518 is attached to the second connector 51 and the fourth connector 91 of the safety circuit unit 5. This packing allows the standard input/output module unit 4 and the safety circuit unit 5 to be waterproof. When the standard input/output module unit 4 is used without the safety circuit unit 5 connected, the first connector 41 and the third connector 81 are covered with a lid. This maintains the waterproof performance of the connector area. The gaskets 517 and 518 are examples of a sealing member in the claims.

Modification 3

The input/output modules 100 and 100A according to the above embodiment and modification include a set of the input standard module unit 40 and the input safety circuit unit 50 for receiving input signals from the devices 71 to be controlled, and also a set of the output standard module unit 80 and the output safety circuit unit 90 for transmitting control signals to the devices 71. However, the two sets may not be included. More specifically, the input/output modules 100 and 100A may include the sets of input standard module unit 40 and the input safety circuit unit 50 rather than the two sets, or the input/output modules 100 and 100A may include the set of the output standard module unit 80 and the output safety circuit unit 90 rather than the two sets. Such an input/output module 100 or 100A also serves as an input/output module.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitably applicable to an input/output module, a standard input/output module unit, and a safety circuit unit.

### REFERENCE SIGNS LIST

1 Base
2 Power supply device
3 CPU module
4 Standard input/output module unit
5 Safety circuit unit
11, 11a, 11b, 11c, 11d, 11e Coupler
12 Network interface
40 Input standard module unit
41 First connector
42 First interface
43, 83 Bus interface
44 First converter
45 First controller
46 Input circuit
47, 87 Power supply circuit
48 First operation setting resistor
50 Input safety circuit unit
51 Second connector
52 Second interface
53 First power supply monitoring/shutoff circuit
54 Second power supply monitoring/shutoff circuit
55 Second converter
56 Second controller
57 Third controller
58 First test pulse output circuit
59 Second test pulse output circuit
60 Second operation setting resistor
71, 71a, 71b, 71c, 71d, 71e, 71f, 71g, 71h Device
80 Output standard module unit
81 Third connector
82 Third interface
84 Third converter
85 Fourth controller
86 Output circuit
88 Third operation setting resistor
90 Output safety circuit unit
91 Fourth connector
92 Third power supply monitoring/shutoff circuit
93 Fourth power supply monitoring/shutoff circuit
94 Fourth converter
95 Fifth controller
96 Sixth controller
97 First readback circuit
98 Second readback circuit
99 Fourth operation setting resistor
100, 100A Input/output module
101, 101A PLC
120 Network connector
121 Network cable
410 First power supply connection contact
411 Second power supply connection contact
412 First control signal communication contact
413 First operation setting contact
414a to 414h First safety control contact
420 First input signal line
421 Second input signal line
422 Third input signal line
423 Fourth input signal line
424 Fifth input signal line
425 Sixth input signal line
426 Seventh input signal line
427 Eighth input signal line
430 First data communication signal line
431 Second data communication signal line
440 First controlling data signal line
441 First controlling address signal line
450a, 450b First signal reception line
451a, 451b Second signal reception line
452a, 452b Third signal reception line
453a, 453b Fourth signal reception line
454a, 454b Fifth signal reception line
455a, 455b Sixth signal reception line
456a, 456b Seventh signal reception line
457a, 457b Eighth signal reception line
460 First input signal transmission line
461 Second input signal transmission line
462 Third input signal transmission line
463 Fourth input signal transmission line
464 Fifth input signal transmission line
465 Sixth input signal transmission line
466 Seventh input signal transmission line
467 Eighth input signal transmission line
470, 870 Driving power supply
471 First power supply joining line
472 Second power supply joining line
480, 880 Pull-up drive power supply
481 First operation setting signal line
510 First power supply monitoring/shutoff contact
511 Second power supply monitoring/shutoff contact
512 Second control signal communication contact
513 Second operation setting contact
514a, 514b, 514c, 514d, 514e, 514f, 514g, 514h Second safety control contact
517, 518 Gasket
520 First diagnosis line
521 Second diagnosis line
522 Third diagnosis line
523 Fourth diagnosis line
524 Fifth diagnosis line
525 Sixth diagnosis line
526 Seventh diagnosis line
527 Eighth diagnosis line
530 First power supply monitoring/shutoff signal line
531 First shutoff instruction signal line
540 Second power supply monitoring/shutoff signal line
541 Second shutoff instruction signal line
550 Third data communication line
551 Second controlling data signal line
552 Second controlling address signal line
560 First safety signal line
561 Third safety signal line
562 Fifth safety signal line
563 Seventh safety signal line
564, 954 Control state determination line
565 First test pulse instruction signal line
570 Second safety signal line
571 Fourth safety signal line
572 Sixth safety signal line
573 Eighth safety signal line
575 Second test pulse instruction signal line
600 First operation setting resistor connection line
810 Third power supply connection contact
811 Fourth power supply connection contact
812 Third control signal communication contact
813, 913 Fourth operation setting contact
814a, 814b, 814c, 814d, 814e, 814f, 814g, 814h Third safety control contact
815a, 815b, 815c, 815d, 815e, 815f, 815g, 815h First readback contact
820 First output signal line
821 Second output signal line
822 Third output signal line
823 Fourth output signal line
824 Fifth output signal line
825 Sixth output signal line
826 Seventh output signal line
827 Eighth output signal line
830 Fourth data communication signal line
831 Fifth data communication signal line
840 Third controlling data signal line
841 Third controlling address signal line
850a, 850b First signal transmission line
851a, 851b Second signal transmission line
852a, 852b Third signal transmission line
853a, 853b Fourth signal transmission line
854a, 854b Fifth signal transmission line
855a, 855b Sixth signal transmission line
856a, 856b Seventh signal transmission line
857a, 857b Eighth signal transmission line
860a, 860b First output signal transmission line
861a Second output signal transmission line
862a Third output signal transmission line
863a Fourth output signal transmission line
864a Fifth output signal transmission line
865a Sixth output signal transmission line
866a Seventh output signal transmission line
867a, 867b Eighth output signal transmission line
871 Third power supply joining line
872 Fourth power supply joining line
881 Second operation setting signal line
910 Third power supply monitoring/shutoff contact
911 Fourth power supply monitoring/shutoff contact
912 Fourth control signal communication contact
914a, 914b, 914c, 914d, 914e, 914f, 914g, 914h Fourth safety control contact
915a, 915b, 915c, 915d, 915e, 915f, 915g, 915h Second readback contact
920 Third power supply monitoring/shutoff signal line
930 Fourth power supply monitoring/shutoff signal line
940 Sixth data communication line
941 Fourth controlling data signal line
942 Fourth controlling address signal line
946 Second readback circuit connection line
950 First diagnosis control signal line
951 Third diagnosis control signal line
952 Fifth diagnosis control signal line
953 Seventh diagnosis control signal line
955 First readback circuit connection line
960 Second diagnosis control signal line
961 Fourth diagnosis control signal line
962 Sixth diagnosis control signal line
963 Eighth diagnosis control signal line
990 Second operation setting resistor connection line

1. An input/output module, comprising:
a standard input/output module unit including
a standard input/output module controller to receive an input signal from a control target device and transmit the input signal to a control module, or transmit a control signal received from the control module to the control target device, and
a first connector including a plurality of connection points; and
a safety circuit unit including
a diagnoser to diagnose operation states of the control target device and the standard input/output module unit,
a second connector including a plurality of connection points and removably insertable into the first connector, and
a safety circuit controller to control operations of the standard input/output module unit and the diagnoser with the second connector inserted in the first connector.

2. The input/output module according to claim 1, wherein
the standard input/output module unit further includes a first operation setter to switch on or off an operation of the standard input/output module controller,
the safety circuit unit further includes a second operation setter to switch on or off an operation of the safety circuit controller,
without the safety circuit unit inserted in the standard input/output module unit, the first operation setter turns on the operation of the standard input/output module controller to cause the standard input/output module controller to control the operation of the standard input/output module unit, and
with the safety circuit unit inserted in the standard input/output module unit, the second operation setter turns on the operation of the safety circuit controller to cause the safety circuit controller to control the operations of the standard input/output module unit and the diagnoser.

3. The input/output module according to claim 1, wherein
the standard input/output module unit includes
an input standard module unit to receive an input signal from the control target device, and
an output standard module unit to transmit a control signal to the control target device, and
the safety circuit unit includes
an input safety circuit unit removably insertable into the input standard module unit, and
an output safety circuit unit removably insertable into the output standard module unit.

4. The input/output module according to claim 1, wherein
the standard input/output module unit further includes a network interface by which the standard input/output module unit and the safety circuit unit are remotely connectable to the safety circuit unit.

5. The input/output module according to claim 1, wherein
the standard input/output module unit and the safety circuit unit each are accommodated in a waterproof housing, and an elastic sealing member is attached to each of the first connector and the second connector.

6.-7. (canceled)

8. The input/output module according to claim 2, wherein
the standard input/output module unit includes
an input standard module unit to receive an input signal from the control target device, and
an output standard module unit to transmit a control signal to the control target device, and
the safety circuit unit includes
an input safety circuit unit removably insertable into the input standard module unit, and
an output safety circuit unit removably insertable into the output standard module unit.

9. The input/output module according to claim 2, wherein
the standard input/output module unit further includes a network interface by which the standard input/output module unit and the safety circuit unit are remotely connectable to the safety circuit unit.

10. The input/output module according to claim 3, wherein
the standard input/output module unit further includes a network interface by which the standard input/output module unit and the safety circuit unit are remotely connectable to the safety circuit unit.

11. The input/output module according to claim 2, wherein
the standard input/output module unit and the safety circuit unit each are accommodated in a waterproof housing, and an elastic sealing member is attached to each of the first connector and the second connector.

12. The input/output module according to claim 3, wherein
the standard input/output module unit and the safety circuit unit each are accommodated in a waterproof housing, and an elastic sealing member is attached to each of the first connector and the second connector.

13. The input/output module according to claim 4, wherein
the standard input/output module unit and the safety circuit unit each are accommodated in a waterproof housing, and an elastic sealing member is attached to each of the first connector and the second connector.

14. A standard input/output module unit, comprising:
a standard input/output module controller to receive an input signal from a control target device and transmit the input signal to a control module, or transmit a control signal received from the control module to the control target device; and
a first connector including a plurality of connection points,
wherein the first connector included in the standard input/output module unit is removably insertable into a second connector including a plurality of connection points, the second connector is included in a safety circuit unit including a safety circuit controller, and the safety circuit controller controls an operation of a diagnoser to diagnose operation states of the control target device and the standard input/output module unit.

15. A safety circuit unit connectable to a standard input/output module unit including a standard input/output module controller to receive an input signal from a control target device and transmit the input signal to a control module, or transmit a control signal received from the control module to the control target device, and a first connector including a plurality of connection points, the safety circuit unit comprising:
a diagnoser to diagnose an operation state of the control target device;
a second connector including a plurality of connection points and removably insertable into the first connector; and
a safety circuit controller to control operations of the standard input/output module unit and the diagnoser with the second connector inserted in the first connector.
